(19) United States
(12) Patent Application Publication
(10) Pub. No.: US 2015/0156175 A1
(43) Pub. Date: Jun. 4, 2015

(54) METHODS FOR SECURING A COMMUNICATION TO A SOCIAL MEDIA APPLICATION AND DEVICES THEREOF

(71) Applicant: Infosys Limited, Bangalore (IN)

(72) Inventors: Puneet Gupta, Bangalore (IN); Akshay Darbari, Bangalore (IN); Hitesh Mathpal, Bangalore (IN)

(21) Appl. No.: 14/493,603

(22) Filed: Sep. 23, 2014

(30) Foreign Application Priority Data
Dec. 2, 2013 (IN) 5538/CHE/2013

(51) Int. Cl. H04L 29/06; G06Q 50/00; G06F 21/60; H04L 29/08

(52) U.S. Cl. CPC H04L 63/0428; H04L 67/10; G06Q 50/01; G06F 21/606

(57) ABSTRACT

The present invention provides a method and system for securing communication of data to a social media application. A set of network routing parameters are configured for the communication. An encrypted response containing a sensitive data is routed from a secure entity to the social media application through a middleware. The encrypted response is intercepted by a decrypting entity based on the configured set of network routing parameters. The encrypted response is decrypted by the decrypting entity and the sensitive data is retrieved. The sensitive data is transmitted by the decrypting entity to the social media application.

This application claims the benefit of Indian Patent Application No. 5538/CHE/2013 filed Dec. 2, 2013, which is hereby incorporated by reference in its entirety.

### FIELD

The technology relates to the field of communications via social medial channels and more particularly to methods for securing a communication to a social media application and devices thereof. More specifically, the present invention relates to methods for securing communication of sensitive data to a social media application and devices thereof.

### BACKGROUND

Social media channels provide an enterprise with important business advantages as well as well-known security threats. The financial benefit gained by acquiring a user's sensitive data such as bank account details, social security numbers, passwords, from the social media channels, is a growing concern to enterprises who intend to use the social media channels such as Twitter, MySpace, Facebook and the like, for communication. Lack of security and trust between an organization, authorized to hold the sensitive data of the user, and the social media channels, prevents the organization from completely exploiting communications and services that are enabled over the social media channels. An inherent fear of malicious attacks to the sensitive data of the user deters a secure end of the organization from opening channels of communication with an untrusted unsecure middleware interface, present in a social media channel.

Hence there is a need for a security mechanism that can mitigate the security risk posed by the untrusted unsecure middleware interface of the social media channel. Further, there is a need for an alternative method that can ensure protection to sensitive data, as the sensitive data traverses from the secure end of the organization through the untrusted unsecure middleware of the social media channel. Such an alternative method shall prevent unauthorized third party access to the sensitive data, as the sensitive data is transferred through the untrusted unsecure middleware. Thus a method and a system that can establish a secure communication over the social medial channel is proposed.

### SUMMARY

The present invention provides a method and system for securing communication of a sensitive data to a social media application. In accordance with a disclosed embodiment, the method may include configuring a set of network routing parameters. An encrypted response containing sensitive data is routed from secure entity to a social media application through a middleware. The encrypted response is forwarded from the middleware to a social media application. Based on the configured set of network routing parameters, the encrypted response is intercepted by a decrypting entity. The sensitive data is retrieved from the encrypted response and transmitted to the social media application.

In an additional embodiment, a system for securing communication of sensitive data to a social media application is disclosed. The system comprises a secure entity, configured to provide an encrypted response containing sensitive data. The system further includes a middleware is configured to route the encrypted response to a social media application. A decrypting entity is configured to intercept the encrypted response, based on a configured set of network routing parameters; and forward the sensitive data to the social media application.

These and other features, aspects, and advantages of the present invention will be better understood with reference to the following description and claims.

### BRIEF DESCRIPTION OF THE DRAWINGS

FIG. 1 shows an exemplary system for securing communication of a sensitive data to social media application.

FIG. 2 is a flowchart illustrating an embodiment of a method of securing communication of a sensitive data to social media application.

FIG. 3 is a flowchart illustrating a preferred embodiment of a method securing communication of a sensitive data to social media application.

FIG. 4 is an example of a computing device useful for performing the processes disclosed herein.

While systems and methods are described herein by way of example and embodiments, those skilled in the art recognize that systems and methods for electronic financial transfers are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

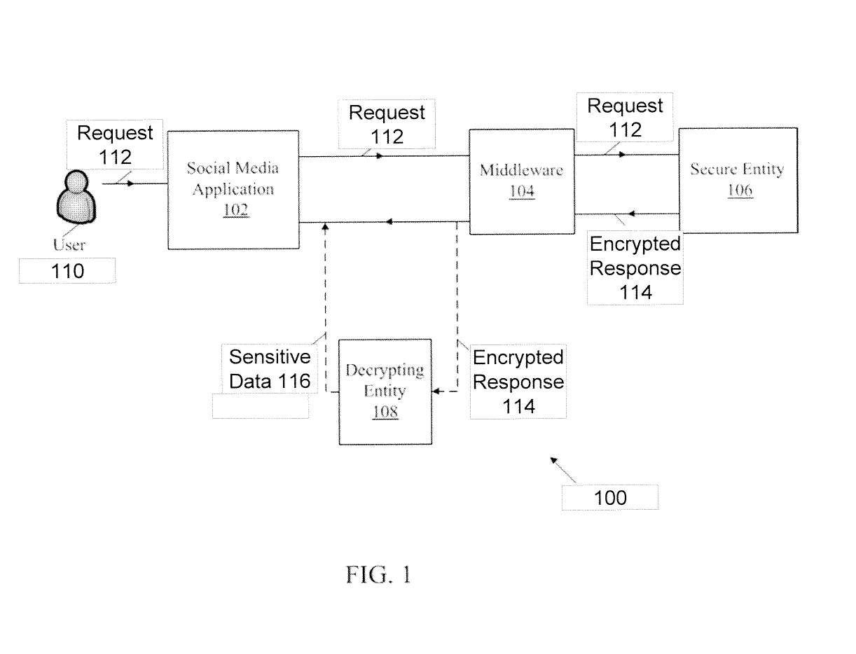

Disclosed embodiments provide computer-implemented methods, systems, and computer-program products for securing communication of a sensitive data to a social media application. FIG. 1 illustrates an exemplary system 100 in which various embodiments of the invention can be practiced. The exemplary system 100 includes a social media application 102, a middleware 104, a secure entity 106, and a decrypting entity 108. The system is deployed over a social media channel. A set of network routing parameters, of the social media channel is configured by an administrator of the network, in a manner such that a communication of a sensitive data 116, over the social media channel is secured from unauthorized access at the middleware 104.

In an embodiment, a user 110 may raise a request 112, for the sensitive data 116, from the social media application 102. The user in one example a person authorized to access the sensitive data 116, where the sensitive data 116 is stored on the secure entity 106. The secure entity 106 is usually a database server of an organization where a plethora of sensitive data of the user, the organization and other confidential information may be stored. The request 112, can be a http request transmitted from the social media application 102. The social media application 102, can be further configured to forward the request 102, to a middleware 104. The middleware 104, can be a third party social network interface, monitored by a third party who may be independent of the secure entity 106.

The middleware 104, shall forward the request 112, to the secure entity 106, for further processing. The secure entity 106, on receiving the request, shall process the request and retrieve the sensitive data 116, and encrypt the sensitive data 116, and compose an encrypted response 114. The secure entity 106 shall route the encrypted response 114, to the social media application 102, through the middleware 104. The middleware 104 on receiving the encrypted response 114, shall forward the encrypted response 114, to the social media application 102. However, based on the configured set of network routing parameters, the decrypting entity 108, can intercept the forwarded encrypted response 114, from the social media channel before the encrypted response 114 reaches the social media application 102. On intercepting the encrypted message 114, the decrypting entity 108, can decrypt the encrypted message 114, based on certain predetermined encryption parameters, and retrieve the sensitive data 116. The decrypting entity 108, shall transmit the retrieved sensitive data 116, to the social medial application 102, based on the configured set of network routing parameters. In the disclosed embodiment, security of the sensitive data 116, on the middleware 104 is attained, as the sensitive data 116, is encrypted in the encrypted response 114, on reaching the middleware 104. The encrypted response 114, shall appear as a meaningless message to the middleware 104, thereby protecting the underlying sensitive data 116, from being compromised.

In the disclosed embodiment, the decrypting entity 108, can be a secure server. In an alternate embodiment the decrypting entity 108, can be a router, a protocol or a gateway. The predetermined encryption parameters maybe set by an administrator of the network. The predetermined encryption parameters shall be synchronized between the secure entity 106 and the decryption entity 108. The encryption parameters may be defined by an existing encryption technique as known in the art.

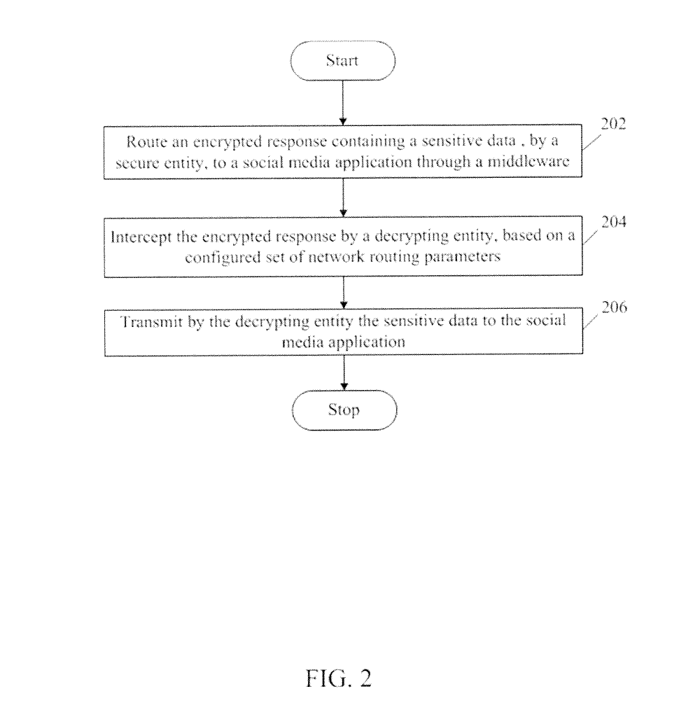

FIG. 2 is a flowchart that illustrates a method performed for securing communication of a sensitive data to a social media application. At step 202, an encrypted response can be routed from a secure entity to a social media application such as Twitter, Facebook, MySpace and the like, through a middleware. The communication of the encrypted response from the middleware to the social media application shall be intercepted at step 204, by a decrypting entity. Intercepting of the encrypted response can be performed by the decrypting entity by configuring a set of network routing parameters, such that even though the middleware addresses the encrypted response to the social media application, the configured network routing parameters, enable the decrypting entity to trace the message on a network path, and capture it for decryption. On decrypting, the encrypted response, the decrypting entity shall transmit the sensitive data to the social media application at step 206.

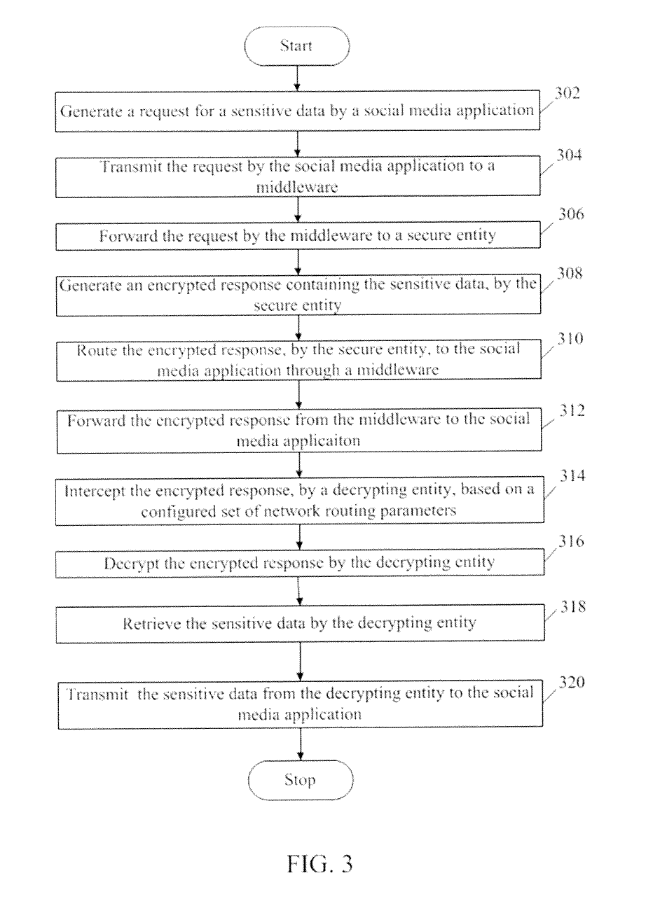

FIG. 3 illustrates an alternate embodiment of a method of practicing the instant invention. At step 302, a request for acquiring a sensitive data of a user, is generated by the user from a social media application. The request for the sensitive data shall be transmitted from the social media application to a middleware, at step 304. At step 306, the request can be forwarded by the middleware to a secure entity, where a plurality of sensitive data of an organization is usually stored. For instance, the secure entity can be a bank server storing confidential information such as bank account details, passwords, and other such sensitive data of the user. The secure entity can be configured to process the request and retrieve the sensitive data. Further, at step 308, the secure entity may encrypt the sensitive data into an encrypted response.

At step 310, the encrypted response can be routed to the social media application through the middleware. The middleware can receive the encrypted response, and forward the encrypted response to the social media application at step 312. At step 314, a decrypting entity shall intercept the encrypted response, as the encrypted response is transferred over a specified network from the middleware to the social media application. The decrypting entity can be programmed to intercept the encrypted response, by configuring a set of network routing parameters, of the specified network over which the encrypted response shall be routed. At step 316, the encrypted response shall be decrypted by the decrypting entity, and the sensitive data present in the encrypted response shall be retrieved in step 318. The retrieved sensitive data shall be transmitted by the decrypting entity to the social media application at step 320.

In an embodiment of the disclosed method, the decrypting entity can be a secure server. In an alternate embodiment the decrypting entity can be a router, a protocol or a gateway. IN the disclosed embodiment, the middleware can be a third party social network interface, which is usually vulnerable to security threats. Encryption of the sensitive data can be done by predetermined encryption parameters as set by an administrator authorized to access the secure entity. Further, the predetermined encryption parameters as utilized by the secure entity shall be synchronized with the decryption entity 108, such that the encrypted response shall be decrypted using similar predetermined parameters used for encrypting the encrypted response. The encryption parameters may be defined by an existing encryption technique as known in the art.

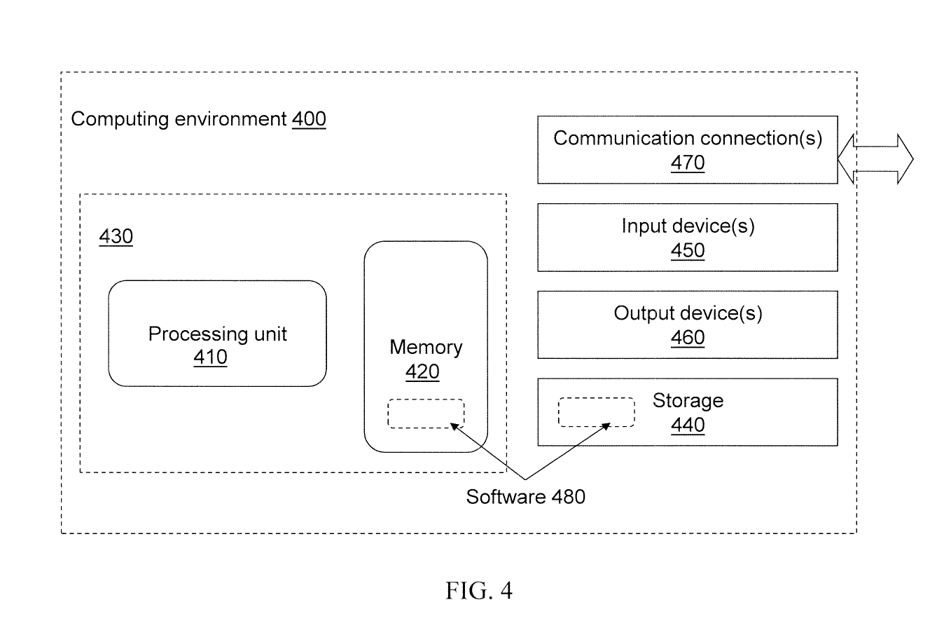

One or more of the above-described techniques can be implemented in or involves one or more computer systems. FIG. 4 illustrates a generalized example of a computing environment 400. The computing environment 400 is not intended to suggest any limitation as to scope of use or functionality of described embodiments.

With reference to FIG. 4, the computing environment 400 includes at least one processing unit 410 and memory 420. In FIG. 4, this most basic configuration 430 is included within a dashed line. The processing unit 410 executes computer-executable instructions and may be a real or a virtual processor. In a multi-processing system, multiple processing units execute computer-executable instructions to increase processing power. The memory 420 may be volatile memory (e.g., registers, cache, RAM), non-volatile memory (e.g., ROM, EEPROM, flash memory, etc.), or some combination of the two. In some embodiments, the memory 420 stores software 480 implementing described techniques.

A computing environment may have additional features. For example, the computing environment 400 includes storage 440, one or more input devices 440, one or more output devices 460, and one or more communication connections 470. An interconnection mechanism (not shown) such as a bus, controller, or network interconnects the components of the computing environment 400. Typically, operating system software (not shown) provides an operating environment for other software executing in the computing environment 400, and coordinates activities of the components of the computing environment 400.

The storage 440 may be removable or non-removable, and includes magnetic disks, magnetic tapes or cassettes, CD-ROMs, CD-RWs, DVDs, or any other medium which can be used to store information and which can be accessed within the computing environment 400. In some embodiments, the storage 440 stores instructions for the software 480.

The input device(s) 450 may be a touch input device such as a keyboard, mouse, pen, trackball, touch screen, a voice input device, a scanning device, a digital camera, or another device that provides input to the computing environment 400. The output device(s) 460 may be a display, printer, speaker, or another device that provides output from the computing environment 400.

The communication connection(s) 470 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 400, computer-readable media include memory 420, storage 440, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

While the foregoing has described certain embodiments and the best mode of practicing the invention, it is understood that various implementations, modifications and examples of the subject matter disclosed herein may be made. It is intended by the following claims to cover the various implementations, modifications, and variations that may fall within the scope of the subject matter described.

What is claimed is:

1. A method for securing a communication to a social media application, the method comprising:
configuring, by a social media application computing device, a set of network routing parameters, wherein the routing parameters route an encrypted response containing sensitive data from a secure entity to the social media application computing device through a middleware device, and further wherein a communication of the encrypted response from the middleware to the social media application computing device is intercepted by a decrypting entity computing device based on the configured set of network routing parameters; and
receiving, by the social media application computing device, the sensitive data from the decrypting entity computing device.

2. The method of claim 1, further comprising:
generating, by the social media application computing device, a request for the sensitive data; and
transmitting, by the social media application computing device, the request to the middleware device, wherein the middleware device forwards the request secure entity and the secure entity generates the encrypted response containing the sensitive data.

3. The method of claim 1, wherein the middleware device forwards the encrypted response to the social media application computing device prior to decryption by the decrypting entity computing device.

4. The method of claim 1, wherein the decrypting entity computing device is one of a secure server, a router, a protocol, or a gateway.

5. The method of claim 1, wherein the secure entity is a database server storing a plurality of sensitive data.

6. The method of claim 1, wherein the middleware device is a third party social network interface.

7. The method of claim 1, wherein the encrypted response is encrypted by one or more encryption parameters, wherein the one or more encryption parameters are based on the social media application stored on the social media application computing device.

8. A social media application computing device comprising:
a processor; and
a memory coupled to the processor which is configured to be capable of executing programmed instructions comprising and stored in the memory to:
configure a set of network routing parameters, wherein the routing parameters route an encrypted response containing sensitive data from a secure entity to the social media application computing device through a middleware device, and further wherein a communication of the encrypted response from the middleware to the social media application computing device is intercepted by a decrypting entity computing device based on the configured set of network routing parameters; and
receive the sensitive data from the decrypting entity computing device.

9. The device of claim 8, wherein the processor coupled to the memory is further configured to be capable of executing the programmed instructions further comprising and stored in the memory to:
generate a request for the sensitive data; and
transmit the request to the middleware device, wherein the middleware device forwards the request secure entity and the secure entity generates the encrypted response containing the sensitive data.

10. The device of claim 8, wherein the middleware device forwards the encrypted response to the social media application computing device prior to decryption by the decrypting entity computing device.

11. The device of claim 8, wherein the decrypting entity computing device is one of a secure server, a router, a protocol, or a gateway.

12. The device of claim 8, wherein the secure entity is a database server storing a plurality of sensitive data.

13. The device of claim 8, wherein the middleware device is a third party social network interface.

14. The device of claim 8, wherein the encrypted response is encrypted by one or more encryption parameters, wherein the one or more encryption parameters are based on the social media application stored on the social media application computing device.

15. The method of claim 8, wherein the secure entity is a database server storing a plurality of sensitive data.

15. A non-transitory computer readable medium having stored thereon instructions for securing a communication to a social media application which when executed by a processor, cause the processor to perform steps comprising:
configuring a set of network routing parameters, wherein the routing parameters route an encrypted response containing sensitive data from a secure entity to a social media application computing device through a middleware device, and further wherein a communication of the encrypted response from the middleware to the social media application computing device is intercepted by a decrypting entity computing device based on the configured set of network routing parameters; and
receiving the sensitive data from the decrypting entity computing device.

16. The medium of claim 15 having stored thereon further instructions which when executed by the processor cause the processor to perform further steps comprising:
generating a request for the sensitive data; and
transmitting the request to the middleware device, wherein the middleware device forwards the request secure entity and the secure entity generates the encrypted response containing the sensitive data.

17. The medium of claim 15, wherein the middleware device forwards the encrypted response to the social media application computing device prior to decryption by the decrypting entity computing device.

18. The medium of claim 15, wherein the decrypting entity computing device is one of a secure server, a router, a protocol, or a gateway.

19. The medium of claim 15, wherein the secure entity is a database server storing a plurality of sensitive data.

20. The medium of claim 15, wherein the middleware device is a third party social network interface.

21. The medium of claim 15, wherein the encrypted response is encrypted by one or more encryption parameters, wherein the one or more encryption parameters are based on the social media application stored on the social media application computing device.
